(19) United States
(12) Patent Application Publication
(10) Pub. No.: US 2010/0017264 A1
(43) Pub. Date: Jan. 21, 2010

(54) APPARATUS FOR SELECTING A PROCESS TO BE CARRIED OUT

(75) Inventor: Rudolf Metz, Koln (DE)

Correspondence Address: Hilderbrand, Christa, 875 Third Avenue, 8th Floor, New York, NY, 10022, US

(73) Assignee: BAYER TECHNOLOGY SERVICES GMBH, LEVERKUSEN (DE)

(21) Appl. No.: 12/438,745

(22) PCT Filed: Aug. 24, 2007
(86) PCT No.: PCT/EP07/07431

§ 371 Date: Mar. 18, 2009

(30) Foreign Application Priority Data
Aug. 30, 2006 (DE) 102006040568.4
Apr. 24, 2007 (DE) 102007019636.0

(51) Int. Cl. G06Q 10/00; G06Q 50/00

(52) U.S. Cl. 705/10; 705/7

(57) ABSTRACT

The invention provides an apparatus for selecting a process to be carried out from a plurality of processes, each process being assigned a process result, having a providing device (101) for providing a first statistical demand density for a first process result of a first process from the plurality of the processes within a process interval, and for providing a second statistical demand density for a second process result of a second process from the plurality of the processes within the process interval, a calculating device (103) for calculating a first process gain, which results upon carrying out the first process, as a function of the first demand density and of a number of the first process results of the first process that can be reached up to a predetermined process time, and for calculating a second process gain, which results upon carrying out the first process, as a function of the first demand density and of a number of the second process results of the second process that can be reached up to the predetermined process time, and a selection device (105) for selecting the first process or the second process as the process to be carried out as a function of a comparison between the first process gain and the second process gain.

### TECHNICAL FIELD

The present invention relates to the selection of a process to be carried out, in particular to the selection of the process to be carried out and the processing quantity thereof, from a plurality of processes in a multiprocessing environment.

### BACKGROUND OF THE INVENTION

If the aim is to be carry out the different processes within a process interval, for example different computer processes or different production processes, it is important to select the quantity to be processed in a step economical with the process, and the sequence of the processes to be carried out is also important, in order to obtain a maximum process gain within a planning horizon.

By way of example, known planning methods always proceed from concrete and prescribed production orders whose target quantity can contain previously determined safety stock, the process gain thereby being diminished.

It is the object of the present invention to provide an efficient concept for selecting a process to be carried out from a plurality of processes.

This object is achieved by the features of the independent claims.

According to the invention, the capacities are distributed on the basis of the stochastic characteristics for the uncertain demand so that the expected gain is maximized.

The present invention provides an apparatus for determining a process, for example to be carried out by a predetermined process time, from a plurality of processes, each process being assigned a process result, for example a product and a produced quantity. The apparatus comprises a providing device for providing a first statistical demand density for a first process result of a first process from the plurality of the processes within a process interval, and for providing a second statistical demand density for a second process result of a second process from the plurality of the processes within the process interval. The process interval can be the planning horizon, for example.

The apparatus further comprises a calculating device for calculating a first process gain (so called Beta Service), which results upon carrying out the first process, as a function of the first demand density and of a number of the first process results of the first process that can be reached up to the predetermined process time, and for calculating a second process gain (so called Beta Service), which results upon carrying out the first process, as a function of the first demand density and of a number of the second process results of the second process that can be reached up to the predetermined process time.

Moreover, the apparatus comprises a selection device for selecting the first process or the second process as the process to be carried out as a function of a comparison between the first process gain and the second process gain.

The process gain can be, for example, that process advantage which results upon carrying out a process with reference to the time required for carrying it out. If the processes are, for example, production processes, the process gain specifies the gain from the production of a product with reference to the time required for production. If, by contrast, the processes are computer processes, the process gain specifies, for example, the reduction, attained upon carrying out a specific process at a specific process time, in the total carrying out time required or the reduced storage requirement. The process gain can, furthermore, comprise a ratio of a process result value of a process result of a process to a process time required for carrying out the process.

In accordance with one aspect, the calculating device is designed in order to calculate the first process gain as a function of a number of first process results that can be reached within the process interval, and in order to calculate the second process gain as a function of a number of second process results that can be reached within the process interval. Furthermore, the calculating device can be designed in order to calculate the first process gain as a function of a demand for first process results, and in order to calculate the second process gain as a function of a demand for second process results. The calculating device can, furthermore, be designed in order to calculate the first process gain on the basis of a difference between an integral over the statistical demand density as a function of a number of first product results, or as a function of a number of first product results that can be achieved within the process interval, and an integral over the statistical demand density as a function of a further number of first product results or as a function of a number of first product results that can be achieved within the process interval, and in this case the calculating device is designed in order to calculate the second process gain on the basis of a difference between an integral over the statistical demand density as a function of a number of second product results or as a function of a number of second product results that can be achieved within the process interval, and an integral over the statistical demand density as a function of a further number of second product results or as a function of a number of second product results that can be achieved within the process interval.

In accordance with one aspect, the apparatus comprises a signaling device for outputting a signal that indicates the process to be carried out The signaling device can, for example, have an electronic display device for displaying the signal indicating the process to be carried out.

The plurality of the processes, or the first process and the second process, can be statistically distributed computer processes or technical product production processes, the statistical demand density of the first process and the statistical demand density of the second process respectively being able to have a Gamma density.

In accordance with one aspect, the apparatus and the devices thereof are implemented as hardware or as software such that all variables occurring are provided and processed in the form of electrical signals.

The invention further provides a method for determining a process to be carried out at a predetermined process time from a plurality of processes, each process being assigned a process result. The method comprises the step of providing a first statistical demand density for a first process result of a first process from the plurality of the processes within a process interval and providing a second statistical demand density for a second process result of a second process from the plurality of the processes within the process interval, the step of calculating a first process gain, which results upon carrying out the first process, as a function of the first demand density and of the number of the first process results of the first process that can be reached up to the predetermined process time, and for calculating a second process gain, which results upon carrying out the first process as a function of the first demand density, and of a number of the second process results of the second process that can be reached up to the predetermined process time, and the step of selecting the first process or the second process as the process to be carried out as a function of a comparison between the first process gain and the second process gain. Furthermore, the method can have the step of outputting a signal that indicates the process to be carried out. Further method steps result from the functionality of the inventive apparatus for determining the process to be carried out.

The present invention further provides a computer program for carrying out the inventive method for determining the process to be carried out, in particular when the computer program is running on a computer.

### DESCRIPTION OF THE DRAWINGS

FIG. 1 shows a block diagram of the apparatus for determining a process to be carried out;

FIG. 2 shows an illustration of the selling probability for the last unit of the stock;

FIG. 3 shows an illustration of the selling probability for the last unit of the stock;

FIG. 4 shows a numerical result of the algorithm; columns A-H relate to product 1, columns I-P relate to product 2.

FIG. 5 shows a further numerical result of the algorithm; columns A-H relate to product 1, columns I-P relate to product 2.

FIG. 6 shows a first algorithm step;

FIG. 7 shows Gamma densities;

FIG. 8 shows some Beta service gains; and

FIG. 9 shows the maximum Beta supply to be expected.

FIG. 10 shows the data flow of BayAPS-PP (process optimization) in cooperation with at production control system for automatically acquired bulk data, such as SAP, for example.

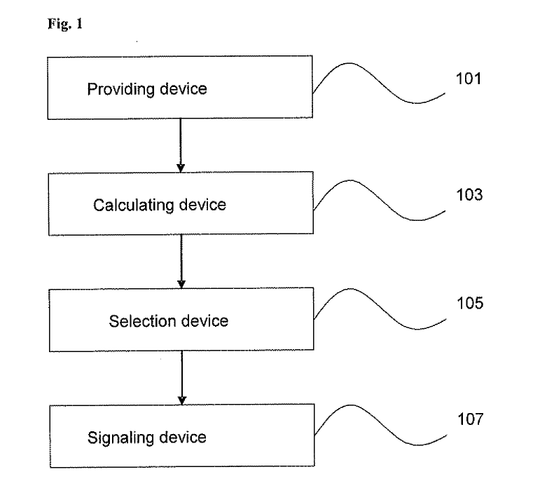

FIG. 1 shows a block diagram of an apparatus for selecting a process to be carried out at a predetermined process time (for example a process to be carried out next). The apparatus comprises a providing device 101 whose output is connected to an input of a calculating device 103. A selection device 105 is connected downstream of the calculating device 103. A signaling device 107 is optionally provided downstream of the selection device 105 in order to indicate the selected process to be carried out.

The inventive apparatus or its functionality can be implemented in accordance with an aspect of software referred to below with the term “BayAPS-PP” (process optimization). It is assumed in the following explanations that the processes to be selected are production or fabrication processes. However, it is to be stressed that the processes to be selected can, for example, be computer processes, technical process sequences, control processes in automatic electronic control systems, or chip control processes.

BayAPS-PP is a software tool that optimizes the entire production of products per production line within a planning period, and its division into production numbers. The optimization means, firstly, maximizing the sales to be expected overall and, secondly, minimizing the average stocks. The model on which the software is based obeys different secondary conditions that are dictated either by the process itself or by organizational restrictions.

It is assumed that BayAPS-PP runs regularly, ideally before a decision has been taken concerning the next production quantity. In this way, as soon as it is possible the BayAPS-PP software exchanges the random demand for a concrete demand and the fabrication or production process becomes a controlled random process.

The BayAPS-PP software requires some master data, and comprises an interface with a production control system, in order to enable automatic acquisition of bulk data with regard to the demand and the stocks.

Examples of master data are start prognosis from history, empirical standard deviation of the prognosis calculated on the basis of historical comparisons of earlier prognosis and master capacity data. Bulk data are current prognoses, unfilled orders and current stock.

The BayAPS-PP algorithm, which forms the core of BayAPS-PP, preferably comprises two steps. In the first step, the production capacity is distributed over different products such that the contribution margin per time unit is optimized. This step is the main part of the algorithm. Gamma densities can be used for the process modeling, but this is not essential, because any other continuous family of densities can be used. However, for practical purposes the aim is not to assume a negative demand, and the density for a given demand and a standard deviation should be unique. Gamma densities are used, for example, in order to model random demand processes. The second step divides the entire production quantity into production lots for the individual products, and prioritizes these production lots.

With regard to the master data, it is possible, for example, to proceed from a definition of a small discrete unit of a product, for example a tonne in a continuous production process with an output performance of 50 000 t per planning horizon, for example half a year. There is thus a definition of an interval for the purpose of dividing the planning horizon. In an industrial environment, a week is frequently used as a measurement unit for the demand forecasts which is used in detailed production sequences. This is denoted as a planning unit. The planning horizon is therefore the sequence w₁, . . . ,wₙ of the planning units.

Each of the v products P₁, . . . ,Pᵥ there is a time t₁, . . . ,tᵥ that is required for producing a product unit. This should supply a realistic forecast of the required time by which a production lot is produced. However, it is not permitted to include any fraction for product change times.

BayAPS-PP calculates with the aid of an average product change time C and a maximum number L of the production lots per time horizon. L is typically determined by staff capacity limitations. Because the algorithm can be carried out very quickly, there is no problem in varying a suitable parameter I and studying its influence. BayAPS-PP optionally optimizes the contribution margin realized overall instead of the realized total number of product units, and then evaluates in addition the contribution margins m₁, . . . ,mᵥ per product and per unit.

As to the bulk data, it is to be assumed that, firstly, the initial quantity s₁, . . . ,sᵥ exists for the products. For each pair Pᵢ, wⱼ, 1≦i≦v, 1≦j≦n of a product and a planning unit there is a random conditional demand Δᵢⱼ in the form of a vector Δᵢⱼ=(μᵢⱼ,σᵣⱼ,rᵢⱼ) that is composed of the (nonconditional) mean value μᵢⱼ, the standard deviation σᵢⱼ and the orders rᵢⱼ already received.

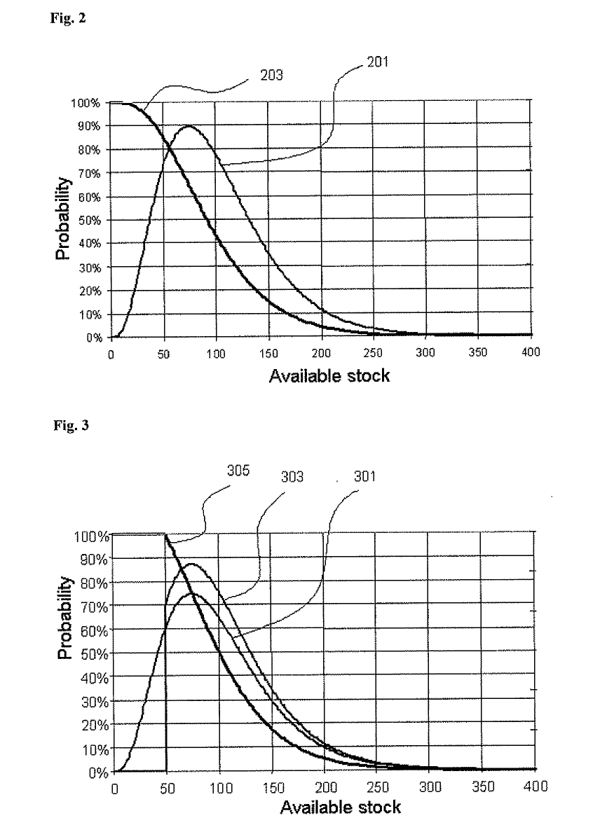

The first step of the algorithm as illustrated in FIG. 2 is explained below, Furthermore, there is an examination of the definition of the inventive Beta service (process gain) required for understanding the core of the BayAPS-PP algorithm.

FIG. 2 shows the profile 201 of the statistical demand density δ. If Δ is the corresponding cumulative distribution, the profile 203 then results with 1−Δ. Located behind the profile 201 is a further profile that is covered by the profile 201 because it is assumed that no orders have come in.

The profile 1−Δ(x) is the probability that there is a demand beyond the quantity x. The demand is sold with the probability 1 beyond the quantity 0, because 1−Δ(0)=1. If an infinite quantity is already available, demand is furthermore sold with the probability 0, since 1−Δ(∞)=0. As would be expected, if average demand is available in stock there is a probability of approximately 0.5. It is to be stressed in this context that the Gamma densities that are used by BayAPS-PP in each case have a different mode, median value and mean value.

In other words, 1−Δ(x) is the contribution of x to the total expected sales for a given random demand with a positive mean value and a positive variance that is represented in BayAPS-PP by the unique Gamma density with these two parameters.

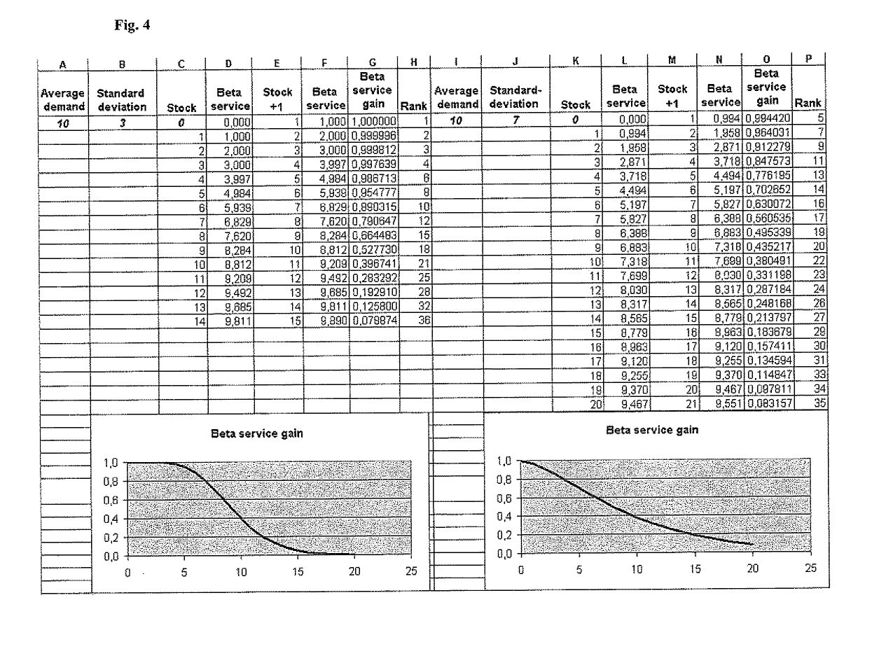

The same situation is investigated below, with the assumption that orders have already come in for 50 units, as is illustrated in FIG. 3. The profile 301 shows the original demand density δ. The profile 303 shows the so-called conditional density δ_{|50}, that results from the condition that the realized value is at least 50 and this results from the assumption of the orders for 50 units that have already come in. The profile 303 results from the profile 301 through a section on the left-hand side, because the demand below 50 has the probability 0. The surface beneath the profile is normalized to 1. In accordance with the preceding exemplary embodiment, the profile 305 is 1−Δ_{|50}, Δ_{|50} being the cumulative conditional distribution. 1−Δ_{|50}, states, as expected, that the first 50 items are sold with the probability 1.

The inventive formulas, which are used to calculate the Beta service (the process gains) and the conditional Gamma demand, are explained below.

The idea on which the algorithm is based is as follows: until the time has expired, produce the next unit for that product which has the highest probable contribution margin. This is only a theoretical sequence, because no change times are considered. At the end, the units produced are acquired for all products. It is to be stressed that the production of a unit for a product generally reduces the probable contribution margin that is attained for a further unit which is produced for this product. If, therefore, the same product is continuously produced, the algorithm determines a saturation for demand and safety stock.

T denotes the period of a planning horizon, and R=T−CL denotes the remaining production time. For each product Pᵢ, 1≦i≦v, the entire random demand is calculated within the planning horizon that is denoted by the vector dᵢ=(μᵢ,σᵢ,rᵢ), where

$${μ}_{i} = {\sum }_{j = 1}^{n} {μ}_{ij} , {σ}_{i} = \sqrt{{\sum }_{j = 1}^{n} {σ}_{ij}^{2}} and {r}_{i} = {\sum }_{j = 1}^{n} {r}_{ij} .$$

This means that the overall mean value, the standard deviation and the orders already obtained are known. The initial number of items xᵢ for each product is xᵢ=sᵢ.

The configuration of the execution loop is as follows:

Investigate the production of a further unit during the remaining time R>0, using the following steps:

Calculate the value

$$( {B}_{δ} ( {r}_{i} , {x}_{i} + 1 ) - {B}_{δ} ( {r}_{i} , {x}_{i} ) ) \frac{{m}_{i}}{{t}_{i}}$$

for each product, δ denoting the Gamma density, which is uniquely determined by μᵢ and σᵢ. This is the gain that is included in the expected contribution margin per unit time for the product Pᵢ. B_{δ}(rᵢ,xᵢ+1)−B_{δ}(rᵢ,xᵢ) is the probably sold fraction of the further units, assuming that the given average demand, the standard deviation and the orders already received are known. mᵢ is the contribution margin referred to a unit and tᵢ is the time required for the production.

Select the product, for example Pₖ, that is the first for which

$$( {B}_{δ} ( {r}_{i} , {x}_{i} + 1 ) - {B}_{δ} ( {r}_{i} , {x}_{i} ) ) \frac{{m}_{i}}{{t}_{i}}$$

assumes the maximum value in the current round, increase xₖ to xₖ+1 and reduce R to R−tₖ. Then execute the loop anew.

If the case should occur that the orders which have already come in for the various products overshoot the total capacity, and that these products have exactly the same contribution margin per time unit, BayAPS-PP proposes a preference to produce those products with a lower product number, and this constitutes one of the then different options of maximizing the contribution margin. If a further unit for a product is being planned, immediately after the production the probability that a next unit for the product is being planned once again is reduced for all orders that have already come in. The exact values depend on the parameters of the conditional demand distribution. The result is that for a product Pᵢ xᵢ−sᵢ units should be produced at a given time within the planning horizon, in order to maximize the overall expected contribution margin within the prescribed rules.

FIG. 4 shows some results of the inventive algorithm, and the profiles of the associated process gains (Beta-Service Gain). For example, two products are considered that require the same production capacity per unit and the same contribution margin. Furthermore, it is assumed in a simple example there are no already received orders, and that no stock in hand is present initially.

The two products have an average demand of 10 units, but a different standard deviation of 3 and 7 units, respectively. Columns D and L respectively list the process gains (Beta Service) for the stock of 0,1,2,3, . . . . Columns G and O respectively list the gain in the Beta Service if the stock is increased by one unit. The two columns G and O are combined to form a list of numbers, and the rank of each number is illustrated in columns H and P respectively.

The first four units are produced for the first product, because the ranks 1 to 4 refer to this product the fifth unit being assigned to the second product. If the total capacity is only 10, the table states that 7 units have been produced for the first product. The reason for this is that column H shows the ranks of at most 10 up to the 7 in column F, and this is relevant to production. Only 3 units remain for the second product. This reflects the case that if the capacity is below the average demand, it is more favorable to produce more for the product with a relatively reliable demand. However, the total production capacity is 30 in all, therefore the table states that 13 units have been produced of the first, and 17 units of the second product.

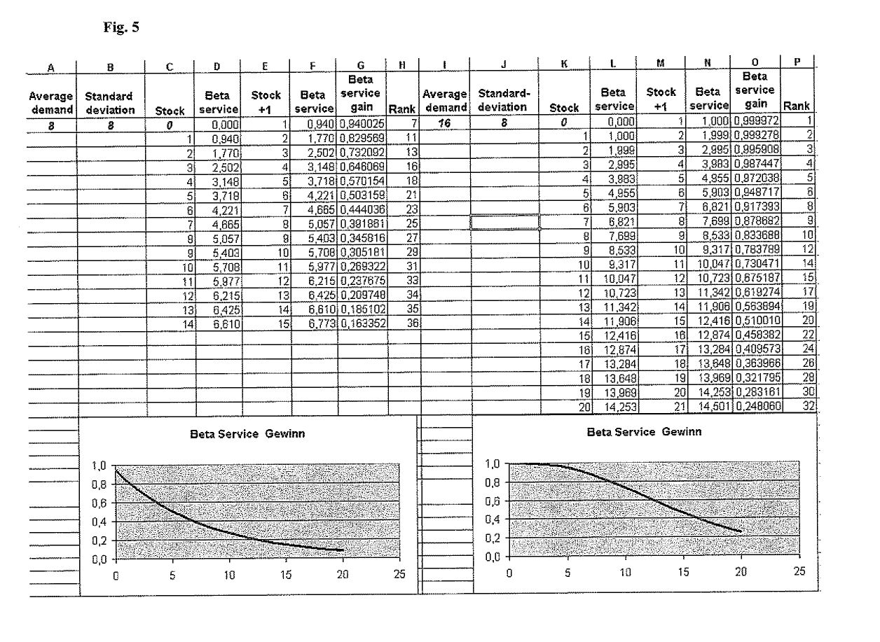

The next variant in FIG. 5 shows two products with different average demands 8 and 16 and with the same relative standard deviations that are 50% of the mean value. By way of example, the algorithm can direct a third of the production capacity onto the first product.

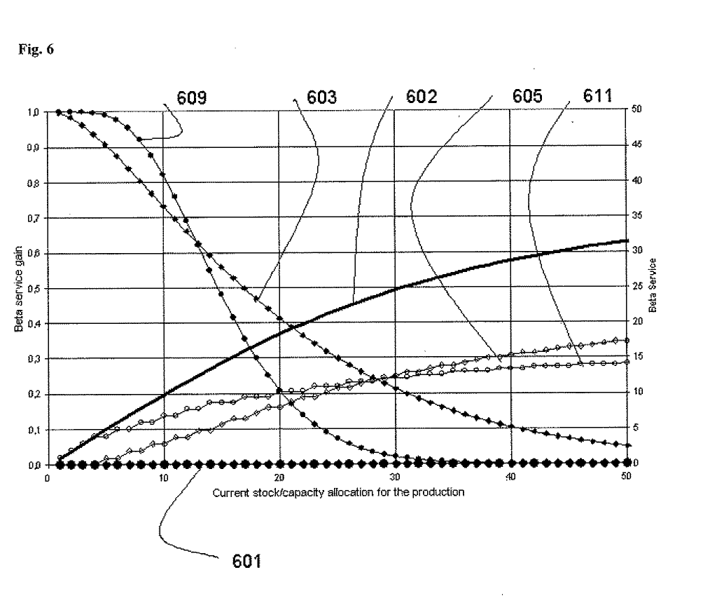

The first step of the BayAPS-PP algorithm is illustrated in FIG. 6, the product A having an average demand of 20 with a standard deviation of 15. The Beta service gain 603 and the Beta service 605 are illustrated for product A. FIG. 6 also shows the associated Beta service gain 609 and the Beta service 611 for product B. Product B has an average demand of 15 with a standard deviation of 6. The two products have an initial stock of 0. They are intended to have the same contribution margin in this example.

The falling profiles express the fact that product B initially has a better Beta service gain because of the low standard deviation. The points on the X axis (601) indicate which product is allocated production capacity in a single individual step of the algorithm. Squares stand for product A, and circles for product B. The first individual steps produce product B because of the low standard deviation. Because only one product is allocated product capacity in a single step of the algorithm, the rising Beta service profiles (605 for product A, 611 for product B) are stair-stepped for both products. Curve 602 is the sum of 605 and 611, and indicates the Beta service that is attained for products A and B together as a function of the number of the capacity allocations for the production.

By way of example, demand smoothing is brought about in the second step. If the demand should temporarily overshoot the production capacity, the BayAPS-PP-Tool attempts to shift the overshooting fraction for the production planning, and this is denoted as demand smoothing. If this is not completely possible, BayAPS-PP inserts delayed products into the plan with higher priority.

The total production for each product is broken down to the given L production lots in a fashion proportional to the square root of the production demand (that is to say demand minus stock). This is a direct development of the known formula of Andler and Harris.

The production of the products is planned as a function of the range of the stocks. The demand forecasts for a product can differ from planning unit to planning unit, orders that have already come in having a precise due date. All this is used in order to calculate the range as precisely as possible.

To be accurate, the sole result is the product for the next production lot and its target quantity. As always at the start of planning, the following production lots serve only as an outlook, and change likewise with the change in the random demand specification (that is to say forecast) and the particular orders that continue to come in. As already mentioned, BayAPS-PP controls the random process and should therefore be used regularly.

The Beta service and the Gamma demand are examined below. Firstly, however, some formulas are specified that are valid for all continuous demand densities. These always have a direct counterpart for discrete densities. As already mentioned, the Gamma densities are often used in order to model a random demand. A Gamma density is uniquely determined by its positive mean value and by its standard deviation. Densities and distributions are assigned uniquely to one another. Distribution uniquely assigned to a Gamma density is called a Gamma distribution. Furthermore, the random numbers cannot assume negative values. A weighting part of the BayAPS-PP planning mechanism is the implementation of the “Beta service for a conditional Gamma demand” as a C++ function.

If δ is a demand density with an associated distribution Δ, and s denotes the available stock, the expected Beta service is then

$${B}_{δ} ( s ) = {\int }_{0}^{s} t δ ( t ) d t + s ( 1 - Δ ( s ) ) .$$

If the quantity r has already been ordered, the conditional demand density δ_{|r}(x)=0 if x<0 and

$${δ}_{\vert r} ( x ) = \frac{δ ( x )}{1 - Δ ( r )}$$

otherwise.

This formula is intuitive. It states that if r is the already ordered quantity, the expected Beta service B_{δ}(r) is exchanged for the specific service r and B_{δ}(r).

If, furthermore, it is assumed that δ is the demand density, r the quantity already ordered and s the available stock, the resulting Beta service B_{δ}(r,s) fulfils the condition B_{δ}(r,s)=s if r≧s and B_{δ}(r,s)=B_{δ}(0,s)−B_{δ}(0,r)+r if r≦s.

As already mentioned, BayAPS-PP applies the present formula in order to calculate the gain in Beta service if a further unit is produced.

With the above notation, the gain in Beta service given an increase of one unit in stock is B_{δ}(r,s+1)−B_{δ}(r,s). By way of example, BayAPS-PP uses Gamma distributions in order to represent the uncertain demand. A Gamma distribution or the associated Gamma density is uniquely determined by its positive mean value and the standard deviation.

The Gamma density g_{(μ,σ)} with the positive mean value μ and the standard deviation σ is defined as

$${g}_{〈 μ , σ 〉} ( x ) = \frac{1}{Γ ( c )} {λ ( λ x )}^{c - 1} {e}^{- λ x} , \\ where λ = \frac{μ}{{σ}^{2}} and c = \frac{{μ}^{2}}{{σ}^{2}} .$$

The above definition of the gain function is preferably used in BayAPS-PP.

If a Gamma distribution random demand with the positive mean value μ and the standard deviation σ is considered, the Beta service gain is B_{δ}(r,s+1)−B_{δ}(r,s), and δ=g_{(μ,σ)} as set forth above.

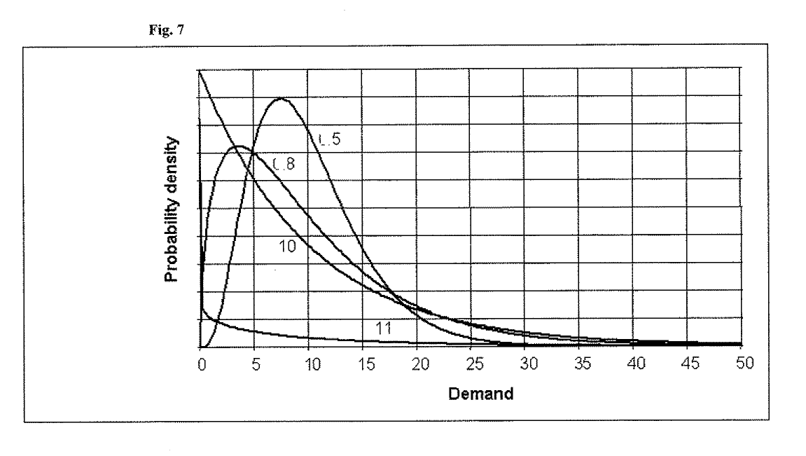

The uncertain demand is modeled in BayAPS-PP by using Gamma densities. Gamma densities are bell shaped if the standard deviation is below the mean value, otherwise they are, conversely, J-shaped. Some Gamma densities with a mean value of 10 and different standard deviations are illustrated in FIG. 7.

Gamma densities raised three important characteristics.

The associated Gamma distributed random numbers never become negative.

For each positive pair consisting of a mean value and a standard deviation, there is a unique Gamma density with these parameters. There is a mathematical technique for multiplying a Gamma density by a (nonintegral) positive number, the result being another Gamma density. This is used, for example, in order to calculate a daily forecast from weekly forecasts on an exact basis. These three characteristics of Gamma densities are the reason why they are often used for modeling random demands.

BayAPS-PP further comprises software routines that encapsulate the calculations on the basis of Gamma densities and distributions. These subroutines could be replaced by equivalent subroutines which are based on a different family of densities and associated distributions, provided that this family of distributions and densities has the three characteristics discussed above. Uncertain demand is modeled such that the demand for a product within a specific period is a random number with a Gamma density that is specified by a mean value μ and a standard deviation σ. It is important to state that μ and σ are influenced differently by the length of the time period considered.

g_{μ,σ}(x) denotes the unique Gamma density with a positive mean value μ and a positive standard deviation σ. G_{μ,σ} is the corresponding (cumulative) distribution.

With

$$λ = \frac{μ}{{σ}^{2}} and c = \frac{{μ}^{2}}{{σ}^{2}} ,$$

g_{μ,σ}(x)=0 for x≦0, and

$${g}_{μ , σ} ( x ) = \frac{1}{Γ ( c )} {λ}^{c} {x}^{c - 1} {e}^{- λ x }$$

for x>0. Γ(n+1) is the continuous interpolation of the factorial function n!. It is to be borne in mind that the convolution (that is to say the stochastic sum) of Gamma densities 1,2, . . . ,n with the same

$$\frac{{μ}_{i}}{{σ}_{i}^{2}} = λ$$

is, in turn, a Gamma density with

$$\frac{μ}{{σ}^{2}} = λ .$$

The use of Gamma densities on the time scale is therefore perfectly natural.

If the available stock is a random number as is the random demand, the supplied quantity is a new random variable B that is the stochastic minimum of the stock and of the demand. B has its own mean value that, when divided by the mean random demand, is denoted as the Beta service level. The calculation is simpler if the available stock is constant and not random.

The following notation is used for the further descriptions:
B_{g}(s) expected Beta service, which is given by the demand density g and the stock s;
B_{g}(c,s) conditional expected Beta service, which is given by the demand density g, the orders c already obtained, and the stock s; and
B_{g}(s)/μ(g) Beta service level.

If g is a random demand density with the corresponding distribution G, and s is the available stock, the mean Beta service is

$${B}_{g} ( s ) = {\int }_{0}^{s} tg ( t ) d t + s ( 1 - G ( s ) ) .$$

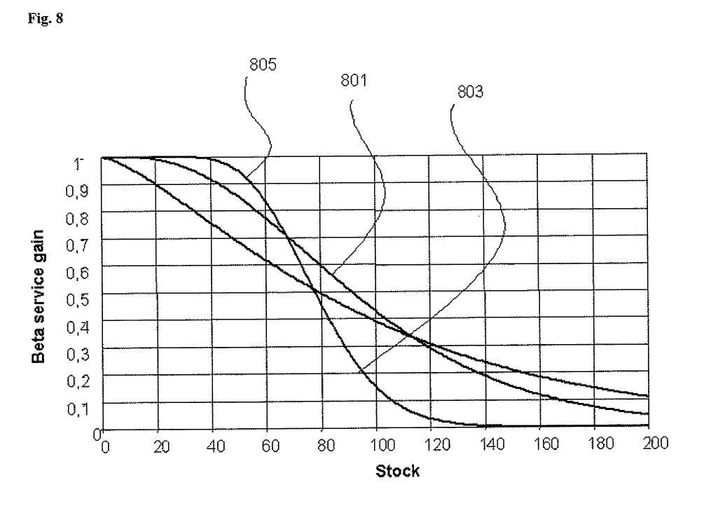

With increasing s, the Beta service gain B_{g}(s+1)−B_{g}(s) vanishes. This is the reason why BayAPS-PP aborts the production of a product if a specific stock has been reached. FIG. 8 shows the Beta service gain for three products as a function of the already available stock.
The product 801 has an average demand of 100 units with a standard deviation of 50.
Product 803 has an average demand of 100 units with a standard deviation of 80.
Product 805 has an average demand of 80 units with a standard deviation of 20.
If the stock for each product is 40 units, it is then more advantageous to produce a further unit of product 805.
If the stock for each product is 80 units, it is then more advantageous to produce a further unit of product 801.
If the stock for each product is 120 units, it is then more advantageous to produce a further unit of product 803.

The calculation of the Beta service can be carried out on the basis on a Gamma recursion formula.

$${\int }_{0}^{x} t \cdot {g}_{λ , c} ( t ) d t = \frac{c}{λ} \cdot {\int }_{0}^{x} {g}_{λ , c + 1} ( t ) d t = \frac{c}{λ} \cdot {G}_{λ , c + 1} ( x ) .$$

It should be borne in mind for a plausibility check that

$$μ ( {g}_{λ , c} ) = {\int }_{0}^{∞} t \cdot {g}_{λ , c} ( t ) d t = \frac{c}{λ} \cdot {G}_{λ , c + 1} ( ∞ ) = \frac{c}{λ} \cdot 1.$$

Orders that have already come in reduce the standard deviation, that is to say the uncertainty of the forecasts, and this is modeled by so-called conditional probability densities.

If the uncertain demand g_{μ,σ}(x) and the orders that have already come in with a total amount of c are considered, the conditional demand density is g_{μ,σ, c}(x)=0 if x<c and

$${g}_{μ , σ , c} ( x ) = \frac{{g}_{μ , σ} ( x )}{1 - {G}_{μ , σ} ( c )}$$

otherwise.

The conditional demand distribution is important for calculating the alpha service level.

If the uncertain demand is considered by G_{μ,σ}(x) and the orders that have already come in with a total amount of c are considered, the conditional demand distribution G_{μ,σ,c}(x)=0 if x<c and

$${G}_{μ , σ , c} ( x ) = \frac{{G}_{μ , σ} ( x ) - {G}_{μ , σ} ( c )}{1 - {G}_{μ , σ} ( c )} .$$

The following formula is advantageous for BayAPS-PP, and states that the fraction B_{g}(0,c) the uncertain supply B_{g}(0,s) is replaced by the certain supply c.

If g denotes a random demand density, s the available stock and c the orders that have already come in, the expected conditional Beta service is B_{g}(c,s)=s if c≧s and B_{g}(c,s)=B_{g}(0,s)−B_{g}(0,c)+c if c≦s.

The sum of the expected Beta service for a plurality of products can be calculated from the uncertain demand, the available demand and the orders that have already come in. The available stock is the current stock plus the produced stock in the initial time interval. An important secondary condition is the production capacity, because the throughput can differ for different products. The optimization calculation is specified by the following vectors for the products 1, . . . ,n.

The following notation is used below for the vectors that describe n products for a production line.

\vec{μ}=(μ₁, . . . ,μₙ) expected demand (mean values) within the planning horizon

\vec{σ}=(σ₁, . . . ,σₙ) standard deviation of the demand

\vec{c}=(c₁, . . . ,cₙ) orders that have already come in

\vec{s}=(s₁, . . . ,sₙ) available stock

\vec{t}=(t₁, . . . ,tₙ) specific time for producing a unit of a product

\vec{x}=(x₁, . . . ,xₙ) total production for each product from beginning to end of the planning horizon

The basic optimization problem is now the overall production:

Maximize the total expected Beta service

$${\sum }_{i = 1}^{n} {B}_{{g}_{i}} ( {c}_{i} , {s}_{i} + {x}_{i} )$$

with gᵢ=g_{μ}_{ᵢ}_{,σ}_{ᵢ} while observing the secondary condition \vec{x}\vec{t}′≦t, t being the total time that is available for the production, that is to say the total time minus the number of campaigns multiplied by an average product change time.

A direct modification would maximize the total Beta supply measured in gains and not in the weights.

A simple example of two products is considered below, and in this case

μ₁=100, μ₂=200, σ₁=50, σ₂=150,

c₁=80, c₂=100, s₁=25, s₂=50,

t₁=t₂=1, t=200.

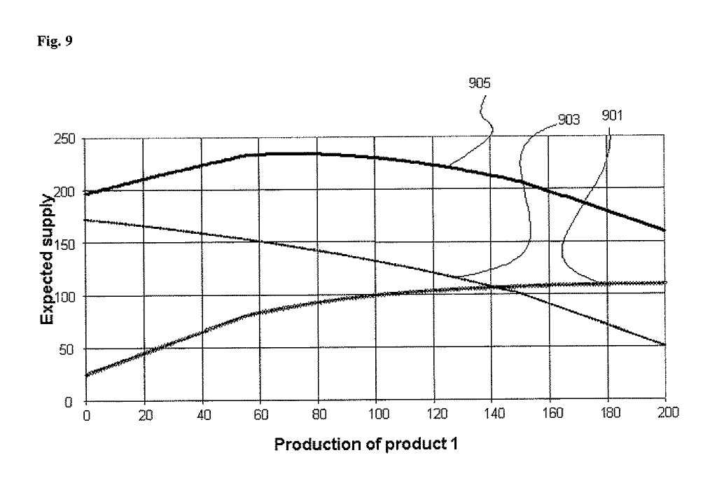

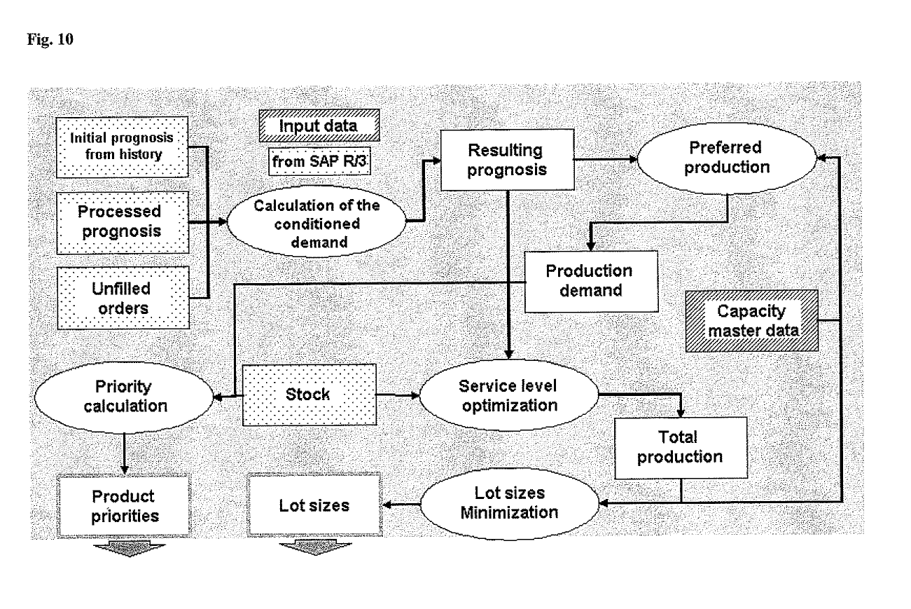

This means that capacities are lacking, because the average demand is 300. The stock is certainly 75, but only 200 units can be produced. The solution x₁=72 and x₂=128 is illustrated in FIG. 9. The profile 901 is the expected Beta supply 1, the profile 903 is the expected Beta supply 2, and the profile 905 is the total Beta supply, that is to say the sum of the two products.

It is to be borne in mind that part of the functions are exactly linear—which would be expected—if the production is between the current stock and the higher orders that have already come in.

The next step is to divide the total production \vec{x}=(x₁, . . . ,xₙ) into a permissible number q of production lots, such that the sum of the lot variables is minimized. If \vec{p}=(p₁, . . . ,pₙ) denotes the lot variables, this gives rise to the optimization problem with reference to the lot variables:

Minimize

$${\sum }_{i = 1}^{n} {p}_{i}$$

under condition

$${\sum }_{i = 1}^{n} \frac{{x}_{i}}{{p}_{i }} \leq q$$

following the minimum lot variables pᵢ≧pᵢₘᵢₙ.

In the last step, BayAPS-PP calculates the stock range for each product by using the week specific forecasts and the orders that have already come in. The range is selected as a priority in order to begin with the reduction of a production lot.

The Beta function is defined twice in accordance with the invention, in a fashion distinguishable by the number of parameters, which is also thus a conversion into an object oriented programming. When it has one parameter, it is the Beta service that results from the demand distribution and the stock (which is the parameter). When it has two parameters, it is a Beta service that results from the demand distribution, the orders (parameter r) that have already come in, and the stock (Parameter s).

The parameter r could also be hidden in the index of Beta that specifies the demand distribution by the simple demand distribution by the conditional demand distribution resulting under the condition that the demand is at least r.

It is preferred to program all the formulas using a modular design of the software. The “conditional Beta service for Gamma distributions” is applied finally. The reason for this is that BayAPS-PP takes account of orders that have already been received with uncertainty 0 and thereafter operates with the aid of the residual prognosis (precisely the conditional distribution).

The following applies to the variables:

rᵢ is the quantity ordered for product i that has already arrived.

xᵢ is the hypothetical stock, that is to say stock so far reached in the algorithm, of the product i, and so x corresponds to the parameter s in the formulas relating to the Beta service, but is called x, because it is searched for in step 1.

tᵢ is the time that is required by the production system to make one “item” of a product i.

C is the average time that is required for a product change, L the number of the production lots (=number of the product changes) that can be made in the planning horizon. In the process industry, there are typically minimum lot sizes for a product that are governed by the technique of the method, and the total number of the production lots is limited, for example because of the staff capacity.

The inventive apparatus and method can be used to determine the following information relating to process optimization planning:
optimum planned quantities, that is to say quantities that can be made and which, measured in the contribution margin (Beta service gain), yield the maximum expected sales over all products in the planning horizon,
determination of the product that is to be produced next,
the exact lot size for the product that is to be produced next. The optimum campaign size is calculated from the maximum number of all campaigns, the product-specific minimum and incremental lot sizes, and the optimally determined total production for each product.

1. An apparatus for selecting a process to be carried out from a plurality of processes, each process being assigned a process result, the apparatus comprising
a providing device (101) for providing a first statistical demand density for a first process result of a first process from the plurality of the processes within a process interval, and for providing a second statistical demand density for a second process result of a second process from the plurality of the processes within the process interval;
a calculator (103) for calculating a first process gain, which results upon carrying out the first process, as a function of the first demand density and of a number of the first process results of the first process that can be reached up to a predetermined process time, and for calculating a second process gain, which results upon carrying out the first process, as a function of the first demand density and of a number of the second process results of the second process that can be reached up to the predetermined process time;
and a selection device (I 05) for selecting the first process or the second process as the process to be carried out as a function of a comparison between the first process gain and the second process gain.

2. The apparatus as claimed in claim 1, wherein the calculator (103) is designed in order to calculate the first process gain further as a function of a number of first process results that can be reached within the process interval, and in order to calculate the second process gain as a function of a number of second process results that can be reached within the process interval.

3. The apparatus as claimed in claim 1, wherein the calculator (103) is furthermore designed in order to calculate the first process gain as a function of a demand for first process results, and in order to calculate the second process gain as a function of a demand for second process results.

4. The apparatus as claimed in claim 1, wherein the first process and the second process are computer processes or technical production processes.

5. The apparatus as claimed in claim 1, wherein the statistical demand density of the first process and the statistical demand density of the second process respectively have a Gamma distribution.

6. The apparatus as claimed in claim 1, wherein the calculator (103) is designed in order to calculate the first process gain on the basis of a difference between an integral over the statistical demand density as a function of a number of first product results and an integral over the statistical demand density as a function of a further number of first product results, and in which the calculator is designed in order to calculate the second process gain on the basis of a difference between an integral over the statistical demand density as a function of a number of second product results and an integral over the statistical demand density as a function of a further number of second product results.

7. The apparatus as claimed in claim 1, wherein the providing device (101), the calculator (103) and the selection device (105) are implemented as hardware or software.

8. The apparatus as claimed in claim 1, further comprising a signaling device (107) for outputting a signal that indicates the process to be carried out.

9. A method for selecting a process to be carried out from a plurality of processes, each process being assigned a process result, comprising the steps of:
providing a first statistical demand density for a first process result of a first process from the plurality of the processes within a process interval, and
providing a second statistical demand density for a second process result of a second process from the plurality of the processes within the process interval;
calculating a first process gain, which results upon carrying out the first process, as a function of the first demand density and of a number of the first process results of the first process that can be reached up to a predetermined process time, and for calculating a second process gain, which results upon carrying out the first process, as a function of the first demand density and of a number of the second process results of the second process that can be reached up to the predetermined process time; and
selecting the first process or the second process as the process to he carried out as a function of a comparison between the first process gain and the second process gain.

10. A computer program for carrying out the method as claimed in claim 9 when the computer program is running on a computer.
